(19) United States
(12) Patent Application Publication
(10) Pub. No.: US 2005/0229566 A1
(43) Pub. Date: Oct. 20, 2005

(54) Tool and method for removing debris from lawnmower decks

(76) Inventor: James Daniel Atkinson, Lexington, KY (US)

Correspondence Address: JOHN B. WOODARD, 8657 TWILIGHT TEAR LANE, CINCINNATI, OH, 45249, US

(21) Appl. No.: 11/108,266

(22) Filed: Apr. 18, 2005

Related U.S. Application Data
(60) Provisional application No. 60/562,926, filed on Apr. 17, 2004.

(51) Int. Cl. A01D 1/00

(52) U.S. Cl. 56/1

(57) ABSTRACT

Curved shapes applicable for making lawnmower cleaning tools for removing debris in a cutting chamber of a lawnmower have been developed. Using these conformally shaped curves improves the performance of mechanically based lawnmower cleaning tools dramatically. The conformal shapes closely conform to the shape of structures found in the cutting chamber of lawnmowers. The shape is designed such that in use, curved portions of tools based on them usually pass within about ¼ inch of the surfaces being cleaned even if the curves touch the cutting chamber surfaces at only one point. Straight portions can be adjacent the curved portions of the curves for cleaning the vertical portions such as a mower skirt around the cutting chamber. The curves can also comprise smaller features designed for cleaning hard to reach areas of the lawnmower cutting chamber.

### CROSS REFERENCE TO RELATED APPLICATION

This application claims the benefit of co-pending U.S. Provisional Patent Application No. 60/562,926 filed Apr. 17, 2004.

### BACKGROUND OF THE INVENTION

In use rotary lawnmowers are exposed to large quantities of grass clippings as the grass is cut by the mower. Many of these mowers are designed to efficiently remove grass clippings from the cutting chamber under the mower deck often through a discharge chute. However, many conditions exist wherein clippings are not efficiently removed from the cutting chamber. Consequently, the clippings often tend to collect in the cutting chamber and build up on its surfaces. The more the clippings build up under the deck, the poorer the performance of the mower becomes. This is reflected in a number of ways among which are clumps of grass on the new mown surface, a rough looking mown lawn that is uneven in terms of remaining grass blade length, and a failure wherein the mower does not cut the grass but just knocks it down. In terms of providing a clean cut, pleasant looking, mowed lawn an unclogged clean mower deck is essential.

The problem is even more evident with mulching mowers. Mulching rotary mowers have become very popular. They permit owners to escape the drudgery of emptying grass collection devices or raking a newly mown lawn to get rid of the cut grass blades. These blades can dry and become unsightly and can even shade or kill the grass in the lawn if not removed.

Mulching mowers work by recirculating grass clippings under the mower deck forcing them to pass through the rotary cutting blade repeatedly. In this way the grass clippings are further processed from their initial cutting and are cut into small pieces that eventually fall to the ground as the mower moves along. These processed clippings are usually of such small size that they tend to fall between the remaining growing grass blades and quickly decompose helping to feed and condition the lawn and the trimmed grass plants.

The problem of grass build-up in the cutting chamber under the mower deck with mulching mowers is even more common than with discharge mowers. Often the problem is initiated by attempting to mow a lawn in which the grass has been allowed to grow too tall for the mulching mower to efficiently process the cut grass. The problem of build-up can also be compounded by attempting to mow a lawn when it is too wet causing the grass to stick to the mower deck and the grass clippings to stick to each other. Nearly everyone who regularly mows a lawn has experienced grass build-up at one time or another.

Lawnmower decks and sides are designed to aid in the functioning of the lawnmower in cutting grass. The lawnmower deck provides two basic functions. These are (1) to support the lawnmower motor, handle and wheels and (2) to control the movement of air and grass clippings in the cutting chamber under the mower deck in some particular way. As described above, in the case of discharge mowers, the object is to remove the cut grass from under the lawnmower. The mower is designed to immediately remove the grass cuttings. In the case of mulching mowers, the object is to recirculate the grass in the cutting chamber through the cutting blade so that it is cut into pieces small enough to rapidly decompose without causing clumps or visible clippings on the mown lawn surface. In both cases the deck of the lawnmower is shaped to enhance air flow and the movement of the lawn clippings in the desired manner to accomplish the purpose of the design. As a consequence of this, the deck of a lawnmower is shaped with curves and chutes to enhance lawnmower performance. Such shaping also can be used to help accomplish strengthening of the lawnmower deck and improved aesthetics.

Debris in the form of grass, mud, leaves, sticks and other matter encountered when mowing often tends to collect on the surfaces of the cutting chamber on the underside of the lawnmower deck impeding air movement and degrading the performance of the lawnmower. To regain the performance of the mower it is necessary to remove the accumulated debris from under the mower deck.

When debris starts to adhere and to build up in the cutting chamber, mower designs are defeated, and the result is poor performance of the lawnmower as discussed above. A method is needed to clean the lawnmower deck and blade. Several methods for accomplishing this have been developed. Although many manufacturers of lawnmowers advise owners not to use water to clean the decks of their mowers, most of the cleaning methods attempt to wash the accumulated grass from the underside surfaces. Consequently, despite the warnings, many owners attempt to clean their mowers using water. These methods usually work to some extent but work best when the build-up of grass is not severe.

However, usually the build-up tends to become severe requiring a more mechanically oriented approach. To that end several hooks, scrapers, spades and similar tools have been developed for removing the build-up. Unfortunately, they all require considerable digging and scraping to remove built up deposits. An apparatus and or a method is needed that allows built up deposits to be quickly and efficiently removed from the underside of mowers without the need for lengthy scraping. Such an apparatus and method should afford complete, efficient cleaning that is easy, effective and quick.

### BRIEF DESCRIPTION OF THE INVENTION

A method is offered for making lawnmower cutting chamber cleaning tools by determining shapes of surfaces found in cutting chambers of lawnmowers. These shapes are then combined to form a common optimal shape that approximates the shape of most lawnmower cutting chambers. The common optimal shape is then applied to shape cleaning tools for removing built up debris.

A tool having parts that match the shape of a lawnmower cutting chamber for cleaning the cutting chamber and its sides is also described. The tool comprises curves that approximate the shape of curved portions of the cutting chamber to within about ¼ inch. It further comprises at least one straight side of length at least equal to the depth of sides surrounding the cutting chamber and structures for cleaning fine geometry features of the cutting chamber.

A method for cleaning lawnmower cutting chambers is also described. The method is accomplished by first determining shapes of surfaces found in cutting chambers of lawnmowers. Subsequently, these shapes are combined to form a common optimal shape that approximates the shape of most lawnmower cutting chambers. Finally, the common optimal shape is applied to make cleaning tools for removing built up debris, and the cleaning tools are used by conformally moving them over the surfaces found in the cutting chambers to remove debris from the surfaces.

### BRIEF DESCRIPTION OF THE DRAWINGS

FIG. 1 is a lawnmower and lawnmower cutting chamber;

FIG. 2 is the common optimal curve shape found;

FIG. 3 is the shapes of five common cutting chamber profiles;

FIG. 4 is curved service tool according to one embodiment of the invention;

FIG. 5 is a curved service tool according to one embodiment of the invention;

FIG. 6 is a curved service tool according to one embodiment of the invention;

FIG. 7 is a curved service tool according to one embodiment of the invention; and

FIG. 8 is a curved service tool according to one embodiment of the invention.

### DETAILED DESCRIPTION OF THE INVENTION

As described above, lawnmower cleaning tools presently available often require a large amount of digging or scraping to remove built up debris in the cutting chamber of lawnmower decks. After much experience and numerous trials it has been observed that when the working edge of a tool is shaped to follow the profile of a lawnmower deck, the removal of debris is much easier from a physical digging and scraping standpoint, is much more effective from a cleaning standpoint, and is also much faster.

In an effort to apply this observation to creating tools for cleaning lawnmowers, a detailed study of how lawnmowers are shaped inside the cutting chamber has been completed. This study involved over 180 measurements of lawnmower deck profiles for a wide variety of brands and models of lawnmowers.

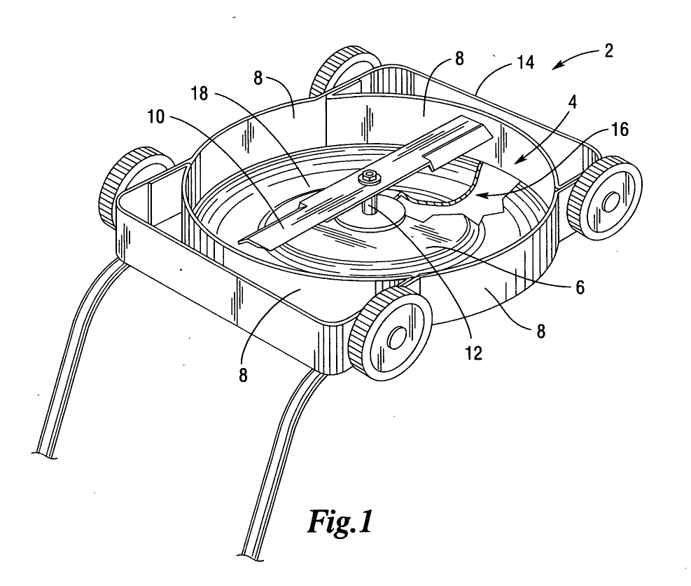

FIG. 1 shows the underside of a lawnmower 2. A lawnmower cutting chamber 4 is usually comprised of the underside of the lawnmower deck 6, skirted sides 8, and can also comprise the rotary mower blade 10 and blade support shaft 12 that connects it to the motor. Often the deck 14 and at least a portion of the skirted sides 8 are made of a single piece of material.

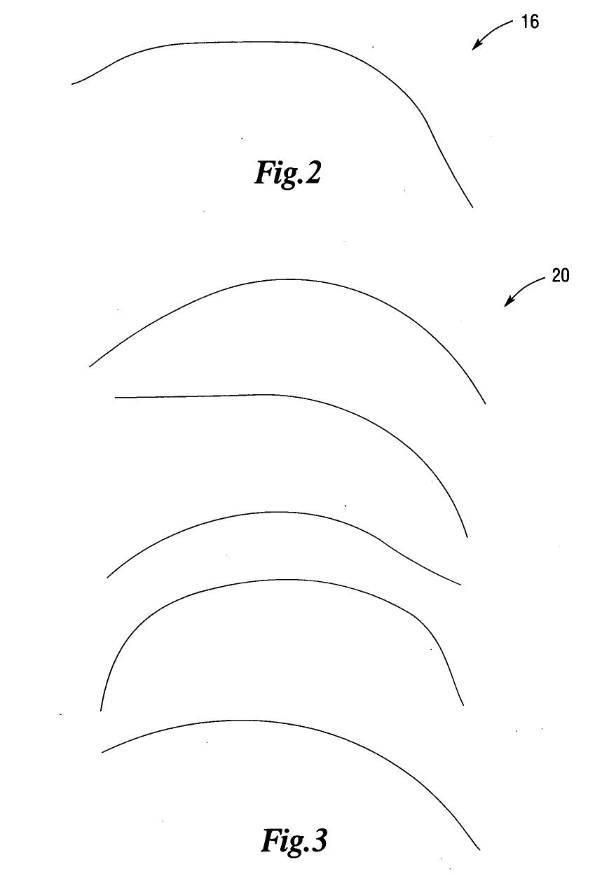

As a result of the study, a common optimal shape that will approximate the shape of the underside 2 of most lawnmower decks 14 studied has been found. The shape found is characterized by the curve 16 shown in FIG. 2. This curve 16 is based on actual contour gauge tracings of the cross sections of lawnmower cutting chamber 4 shapes. As shown, this curve 16 is an approximate cross section of the shape of most air handling chutes 18 in most common lawnmowers.

During the study, several other curves were identified that also closely approximate the common shape of the deck 14 undersides with regard to air and cut matter handling. Most of these are reasonably close to the curve 16 shown but can vary in minor ways.

FIG. 3 shows the five other most common shapes 20. These shapes 20 are all based on cross sectional tracings taken with a contour gauge of the configuration of various lawnmower cutting chambers 4, and they refer primarily to the air handling chutes 18 that comprise the configuration of the deck 14 underside and the sides of the cutting chamber.

In addition it was found that there are often other shapes in the mower deck 14 that appear to have been incorporated for strengthening and in some cases for aesthetics. These, usually, are of much smaller geometry than the main chutes 18. Consequently, it is desirable to have available devices with smaller geometries when cleaning them.

It was also found that another common shape found in the cutting chamber 4 of a lawnmower is a straight shape corresponding to the sides or curtain 8 that often surrounds the cutting chamber 4. While in some lawnmowers these sides 8 are curved vertically, in many lawnmowers they are straight vertically and conformal cleaning is best accomplished with a tool having a straight side of sufficient length to span the whole vertical height of the side of the cutting chamber 4. The study showed that such sufficient length significantly reduces the time that it takes to clean a cutting chamber 4. The study also showed that it is usually important to limit the length of tools based on the straight side to lengths that are approximately equal to the length of the straight side to avoid unwanted flexing and other unwanted ease of use and efficiency issues. Making the length of tools for lawnmower cleaning longer than needed to effectively clean the surfaces that need cleaning, leads to unwieldy and difficult to use tools. It was found in the study that, generally, the best length for such tools is from 3¼ inches to 3½ inches corresponding to the height of the curtained sides 8 of most lawnmowers.

Traveling around its circumference, the curtained side 8 surrounds the cutting chamber and is always circular around the circumferential direction for mulching mowers because of the circular nature of blade movement when cutting. For discharge rotary mowers the sides of the chute even where it exits the cutting chamber tend to be straight in many lawnmowers.

The invention combines these shapes into curves 16, 20 that can be employed to construct a variety of cleaning tools for a lawnmower. Importantly, all of them conformally follow the shapes found in the cutting chamber 4 of a lawnmower deck 14, and this conformal matching to the shapes found in a cutting chamber 4 is what gives these tools their improved ability to clean more thoroughly, efficiently and effectively than previous tools.

Several different tools have been prepared by combining these above shapes. In testing them, it has been found that when cleaning a lawnmower, the tool shape can vary from the exact shape of the cutting chamber 4 within limits. For example, when a tool based on the established curves 16, 20 touches the surface being cleaned at one or more points and passes the rest of its working edge or working surface within about ¼ inch of the surface being cleaned, that surface will usually be freed from debris build up. Because of this, tools based on the invention need only be approximately conformal with the shape being cleaned to within about ¼ inch.

While various diameters or widths of tools based on the optimal curve 16 work for most tools, it has been found that the most effective widths of tools based on the invention is from about 1⅞ inches to about 2 inches. This ensures that tools based on the invention are likely to fit most existing cutting chambers and that in use the chute shaped end of the cleaning tools will pass within about ¼ inch of the surface being cleaned. Limiting the width of the cleaning tools also allows a lower power tool operating driver such as an electric drill to power the tools effectively. When a hand tool is prepared based on the invention, limiting the size of the tool as indicated above helps insure ease of use based on the physical strength of the user.

As discussed above, it has been found that it is usually desirable to make the straight sides for cleaning the flat vertically, but curved longitudinally, surfaces such as the cutting chamber skirt 8 about 3½ inches to 3½ inches long to accommodate the width of the flat in one dimension surfaces comprising the cutting chamber skirt 8.

In further developing the invention, it has been found that the shape of the optimal curve 16 of FIG. 2 can be approximated by creating a tool cross section that has a circularly curved working edge that is about 2¼ inches in radius. For tools constructed with a diameter of from about 1⅞ inches to about 2 inches this insures that, in use, the tool working surface will substantially pass within about ¼ inch of the surface being cleaned.

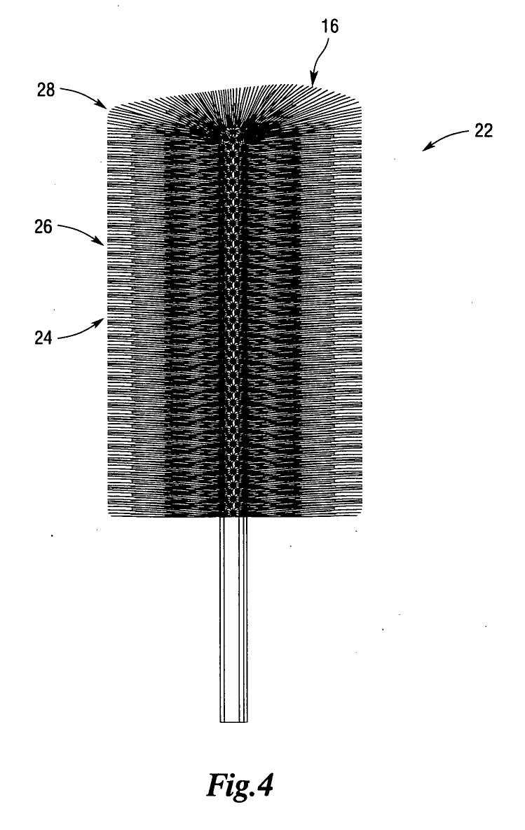

FIG. 4 shows how these shapes can be incorporated in a wire brush tool 22. In FIG. 4 a wire brush tool 22 is created incorporating the optimal common curve 16 shown in FIG. 2. The wire brush tool 22 is formed by creating a shape that is determined by rotating the optimal conformal curve 16 about the axis of rotation of the tool as it would be used and adding a straight cylindrical portion of the brush 24. The optimal conformal curve 16 is used to improve contact on the chute and air/clipping handling surfaces 18. The straight sides 26 can be used for cleaning the flat surfaces found inside the curtained sides 8 of the cutting chamber 4. This is accomplished using the straight cylindrical portion of the brush 24. In this particular embodiment the fine features in the cutting chamber can be cleaned by forcing the brush 22 transition 28 between the optimal conformal curve 16 and the straight sides 26 into the areas exhibiting fine geometry.

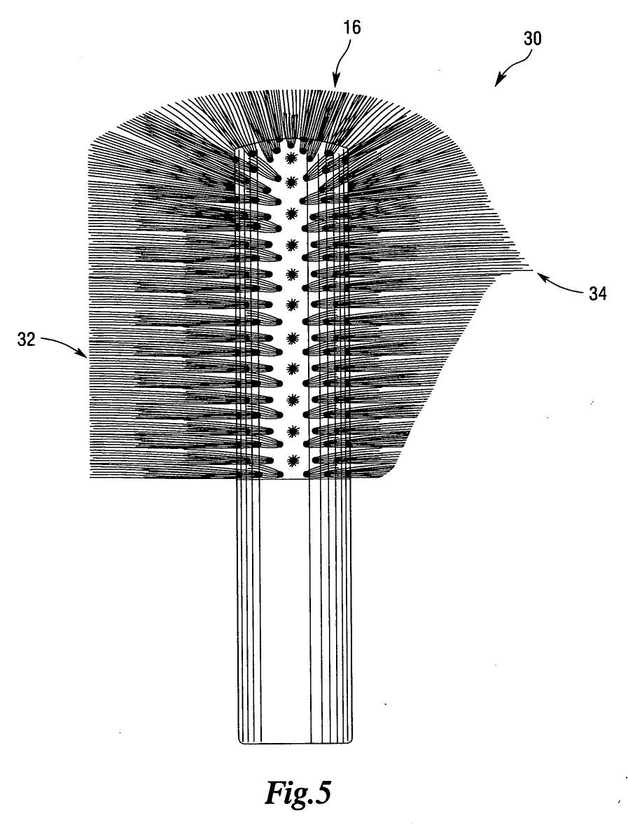

FIG. 5 demonstrates another embodiment wherein a wire brush tool 30 based on the invention is hand operated, is provided with the optimal conformal curve 16 for cleaning the grass handling chute 18, and incorporates a straight side 32 for cleaning relatively flat surfaces. The cusp 34 formed at the end of the optimal conformal curve 16 is also convenient for cleaning areas of finer geometry in the cutting chamber of a lawnmower. In this embodiment the tool 30 can be operated by hand using a back and forth scrubbing motion to penetrate the debris build up in the cutting chamber 4 and to remove the debris. The straight side of the tool 32 is designed to conform to the flat surfaces such as can be encountered on the sides of the cutting chamber 4. This embodiment of the invention is particularly effective in cleaning surfaces down to bare metal allowing one to remove most stubborn debris.

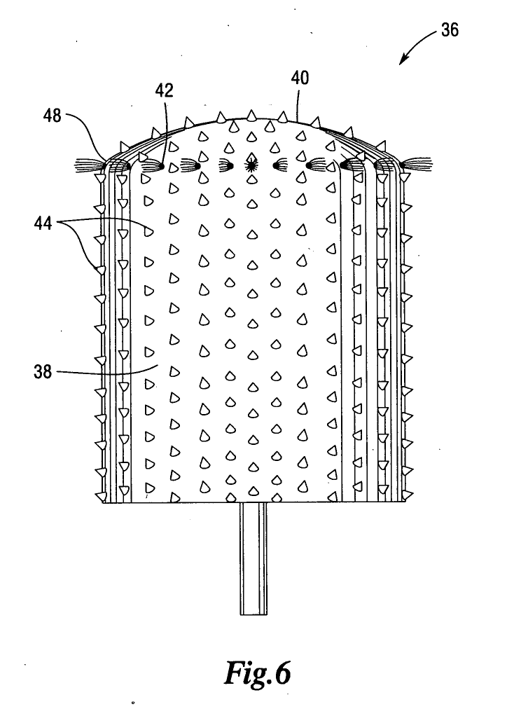

FIG. 6 is another embodiment comprising a shaped studded tool 36 that is based on the optimal conformal curve 16 for cleaning the curved surfaces of the cutting chamber 4 and further comprises a studded cylindrical portion 38 for surfaces with a flat profile. The FIG. 6 embodiment employs the approximation of the optimal conformal curve 16 mentioned above. A circular arc having a radius of about 2¼ inches 40 is used to approximate the optimal conformal curve 16. Using such an arc 40 in this case allows one to use a rocking back and forth from side to side motion as the tool 36 is moved along the curved chute 18 in the cutting chamber 4 while still keeping most of the working surface along the curved portion 40 of the tool 36 within about ¼ inch of the surface being cleaned. The small amount of latitude gained is effective in helping to remove hardened debris from the surfaces of the cutting chamber 4. This aggressive cleaning tool 36 can remove hardened dried on debris in the cutting chamber 4 of a lawnmower. The tool 36 is designed to be powered with a rotary driver such as an electric drill. An important feature of this tool 36 is that it has a line of wire strands 42 that are longer than the studs 44 near the transition 48 from the conformal curve to the straight sides. These wire strands 42 are for cleaning the finer geometry parts of the cutting chamber 4. They are disposed so as to avoid interfering with the cleaning action of the studded portion of the tool 36 and are flexible enough to fold down when the studded portion of the tool 36 is brought into contact with the surfaces of the cutting chamber 4.

As noted above, this tool 36 is designed for more aggressive cleaning. Often people let their lawnmowers sit for extended periods of time with clogging debris present before cleaning them. During that time the debris can harden and become encrusted making it difficult to remove, and this tool is designed to remove it.

The invention can be employed in various other hand tools.

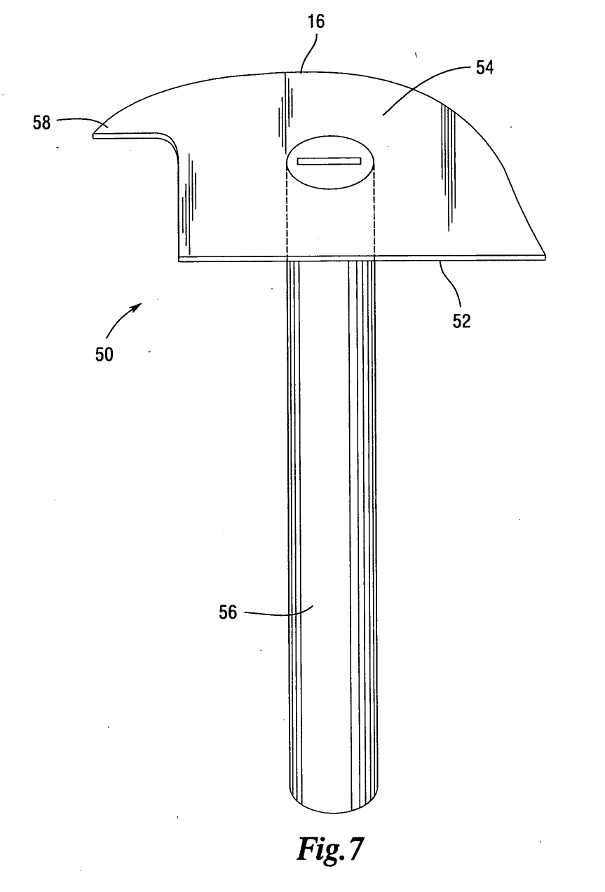

FIG. 7 shows a tool 50 that incorporates the optimal common curve 16 of FIG. 2 on the curved side for cleaning the curved surfaces in the cutting chamber 4 of a lawnmower underside 2 and also comprises a straight portion 52 for cleaning surfaces that are straight in at least one dimension in the cutting chamber 4. This tool 50 can be made of a single piece of flat material 54 with a handle 56 attached to it as shown. The width of the curved portion 16 of the blade is typically about 2 inches but can span the entire width of the optimal curve 16 of FIG. 2 as is shown in FIG. 7. Also, in this embodiment a spike shaped protuberance 58 is provided for getting into and cleaning areas of fine geometry in the cutting chamber 4. The length of the straight portion of the blade 52 is typically about 3¼ to about 3½ inches as described above and is made to conform to the vertical length of the side curtain 8 of a typical lawnmower's cutting chamber 4.

In use this tool 50 can be used to scrape debris from the surface of the lawnmower cutting chamber 4. By using the optimal curve 16 on the edge to match the shapes found in the cutting chamber 4 cleaning time is reduced to a minimum, and the results of cleaning in most situations are excellent. One advantage of this embodiment is that both hands can be used to grasp the handle 56 of the tool 50 permitting one to apply more force if needed than if just one hand is used.

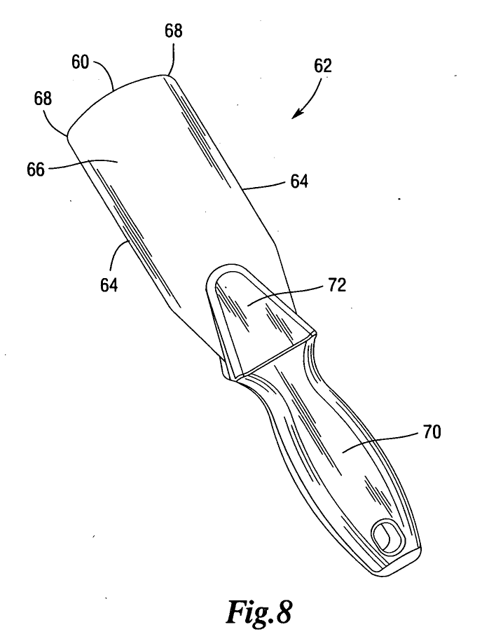

From another aspect FIG. 8 extends the invention to hand tools designed to be used with one hand. In this embodiment the curved end 60 of the tool 62 is a circular arc of about 2¼ inches in radius and approximates the optimal curve 16 as discussed above.

Having a tool 62 width of from about 1⅞ inches to about 2 inches, the tool 62 approximately fits the curvature of the mower deck 14 inside the cutting chamber 4. As discussed previously, this causes the tool 62 to be effective in cleaning the curved surfaces of the mower deck 14 inside the cutting chamber 4.

The tool 62 incorporates sides 64 that are about 3¼ to about 3½ inches in length. As in other embodiments, these straight sides 64 are useful for removing debris from the curtained side surfaces 8 of the cutting chamber 4. The length of the sides 64 in this embodiment relates to the flexibility of the blade 66 of the tool 62 when in use. Also, because it is a one handed tool 62, the user can use the tool 62 more easily if the sides 64 are approximately the same length as the depth of the sides 8 of the cutting chamber 4.

In this configuration the transitions 68 between the curved end 60 and the straight sides 64 are useful for cleaning the finer geometries in the cutting chamber 4. The corner transitions 68 can be modified to incorporate shapes specifically designed for cleaning the places of finer geometry in the cutting chamber 4. However, in this embodiment the normal transition 68 from the curved end 60 to the straight sides 64 is usually adequate to reach all the areas of the cutting chamber that need to be cleaned.

In this embodiment, it has been found that controlling blade 66 flex is a useful way to get improved performance from the tool 62. Excessive blade 66 flex can make it difficult to lift and remove debris from the surface of the cutting chamber 4. Too little blade 66 flex can force the user to scrape the surface rather than to penetrate, lift and remove debris. To control blade 66 flex the handle 70 can incorporate a support tab 72. This support tab 72 controls flex in the blade 66 by supporting the center of the blade 66, controlling lateral as well as longitudinal flex in the blade 66. It has been found as a part of the study conducted that this method of controlling blade 66 flex leads to improved performance and increased speed in cleaning the lawnmower cutting chamber 4.

Those skilled in the art will realize that this invention is capable of embodiments different from those shown and described. It will be appreciated that the detail of the structure of this apparatus and methodology can be changed in various ways without departing from the scope of this invention. Accordingly, the drawings and detailed description of the preferred embodiments are to be regarded as including such equivalents as do not depart from the scope of the invention.

1. a method for making lawnmower cutting chamber cleaning tools comprising the steps of:
a) determining shapes of surfaces found in cutting chambers of lawnmowers;
b) determining a common optimal shape that approximates shapes found in most lawnmower cutting chambers; and
c) applying the common optimal shape to make at least one cleaning tool for removing debris.

2. The method of claim 1 wherein the common optimal shape of the at least one cleaning tool causes at least one working edge of the cleaning tool to touch the cutting chamber in at least one place and wherein the common optimal shape of the cleaning tool causes the rest of the working edge to pass within about ¼ inch of the surface being cleaned.

3. The method of claim 1 further comprising including at least one straight portion in the at least one cleaning tool for cleaning cutting chamber sides.

4. The method of claim 3 wherein the at least one straight portion of the at least one cleaning tool is at least as long as the depth of the cutting chamber sides.

5. The method of claim 3 wherein the at least one straight portion of the at least one cleaning tool is about equal in length to the depth of most lawnmower cutting chamber sides.

6. The method of claim 1 further comprising including at least one small geometry feature in the at least one cleaning tool for cleaning small geometry features of lawnmower cutting chambers.

7. The method of claim 1 wherein the at least one cleaning tool has a width of from about 1⅞ inches to about 2 inches.

8. The method of claim 1 wherein the common optimal shape is approximated by a circularly curved arc.

9. The method of claim 8 wherein the circularly curved arc is about 2¼ inches in radius.

10. A tool having parts that match the shape of a lawnmower cutting chamber for cleaning the cutting chamber, the tool comprising:
a) at least one curve that approximates the shape of curved portions of the cutting chamber to within about ¼ inch;
b) at least one straight side of length at least equal to the depth of sides surrounding the cutting chamber; and
c) at least one structure for cleaning fine geometry features of the cutting chamber.

11. The tool of claim 10 wherein the width of the tool is from about 1⅞ inches to about 2 inches.

12. The tool of claim 10 wherein the at least one curve is approximated by a circular curved arc.

13. The tool of claim 12 wherein the circular curved arc is about 2¼ inches in radius.

14. The tool of claim 10 further comprising a blade and a handle wherein the handle comprises a strengthening tab to control the flex of the blade.

15. A method for cleaning lawnmower cutting chambers comprising the steps of:
a) determining shapes of surfaces found in cutting chambers of lawnmowers;
b) using the shapes to determine a common optimal shape that approximates the shape of most lawnmower cutting chambers;
c) applying the common optimal shape to make at least one cleaning tool for removing debris; and
d) using the cleaning tool by moving it over the surfaces found in the cutting chamber to remove debris from the surfaces.

16. The method of claim 15 wherein the shape of the at least one cleaning tool causes the working edge of the at least one cleaning tool to touch the cutting chamber in at least one place and causes the rest of the working edge of the at least one cleaning tool to pass within about ¼ inch of the surface being cleaned.

17. The method of claim 15 further comprising including at least one straight portion in the at least one cleaning tool that is at least as long as the depth of cutting chamber sides.

18. The method of claim 15 further comprising including at least one small geometry feature in the at least one cleaning tool for cleaning small geometry features of lawnmower cutting chambers.

19. The method of claim 15 wherein the at least one cleaning tool has a width of from about 1⅞ inches to about 2 inches.

20. The method of claim 15 wherein the common optimal shape is approximated by a circularly curved arc to form a working edge.
